(19) United States
(12) Patent Application Publication
(10) Pub. No.: US 2008/0085956 A1
(43) Pub. Date: Apr. 10, 2008

(54) Fireproof Thermoplastic Compounds, Method for the Production Thereof

(76) Inventors: Christelle Recoquille, Nassandres (FR); Philippe Blondel, Bernay (FR); Jean-Jacques Flat, Goupillieres (FR); Jean-Claude Marais, Le Neubourg (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/630,237

(22) PCT Filed: Jul. 1, 2005
(86) PCT No.: PCT/FR05/01686

§ 371 Date: Dec. 20, 2006

(30) Foreign Application Priority Data
Jul. 2, 2004 (FR) 0407362

(51) Int. Cl. C08K 5/3477; C08L 77/00

(52) U.S. Cl. 524/101

(57) ABSTRACT

The invention relates to flame-retardant thermoplastic compositions comprising a blend of PA-11 and PA-12 polyamide resins and melamine cyanurate, their method of preparation and their application in the manufacture of industrial articles.

This application claims benefit, under U.S.C. §119 or §365 of French Application Number 04.07362, filed Jul. 2, 2004, and PCT/FR05/001686 filed Jul. 1, 2005.”

### FIELD OF THE INVENTION

The subject of the present invention is flame-retardant thermoplastic compositions based on polyamide resins having good mechanical characteristics, a good thermal and chemical resistance and good fire-resistance properties and also their method of preparation.

Due to their excellent physical properties, thermoplastic polyamide resins are widely used in many applications in the automotive industry, aeronautics, the electrical field, etc., but their development is sometimes held back because of their combustibility.

### BACKGROUND OF THE INVENTION

Numerous solutions have been proposed in the literature for improving the combustion resistance of polyamide-based thermoplastic compositions.

Halogenated derivatives such as decabromodiphenyl ether or decabromodiphenyl, optionally in combination with Sb₂O₃, have been added but the halogenated compounds generate halogenated acids which are released during the manufacture and/or during the use and/or during the combustion of the compositions into which they are incorporated, thus resulting in risks of corrosion of the equipment and in pollution of the environment.

Antimony oxide Sb₂O₃ is also used in combination with magnesium hydroxide and optionally melamine cyanurate in EP 571 241 in the name of the Applicant, for imparting flame retardancy to polyamide thermoplastic compositions.

Melamine cyanurate improves the combustion resistance of polyamides but it is not as effective, weight for weight, as certain compounds with a high chlorine or bromine content.

It is also known to incorporate phosphorus or its derivatives, such as red phosphorus (U.S. Pat. No. 3,778,407), phosphites or phosphates.

In EP 169 085 in the name of the Applicant, a polyol and melamine cyanurate are added simultaneously to polyamide-based compositions in order to improve the fire resistance.

In EP 758 002 in the name of the Applicant, antimony oxide Sb₂O₃, melamine cyanurate and one or more polyols are added to thermoplastic compositions based on a polyamide resin that contain aliphatic and/or cycloaliphatic and/or aromatic units in order to improve the combustion resistance. The compositions described are based on a polyamide resin such as PA-11, PA-12, PA-12,12, coPA-6/12 and/or PEBA.

The preparation method described in EP 758 002 may be used for prior preparation of a masterbatch of the constituents then subsequent redilution of the masterbatch in the final resin, the resin of the masterbatch possibly being identical to or different from the final resin.

The Applicant has now found flame-retardant thermoplastic compositions having improved properties.

### SUMMARY OF THE INVENTION

The subject of the invention is therefore a flame-retardant thermoplastic composition comprising a blend of PA-11 and PA-12 polyamide resins and melamine cyanurate.

According to one embodiment, the PA-12/PA-11 ratio in the composition lies in the range going from 99/1 to 1/99, preferably from 95/5 to 50/50 or else from 90/10 to 60/40.

Preferably still, the PA-12/PA-11 ratio lies in the range going from 85/15 to 50/50.

According to one embodiment, melamine cyanurate represents 5 to 20%, and preferably 10 to 15% of the total weight of the composition.

According to another embodiment, the thermoplastic composition further comprises fire-retardant additives chosen from one or more polyols containing the alcohol functional group at least four times, antimony oxide Sb₂O₃, magnesium hydroxide Mg(OH)₂, ammonium polyphosphate, phosphorus derivatives or mineral nanofillers.

Preferably, the fire-retardant additive is chosen from polyols containing the alcohol functional group at least four times, preferably monopentaerythritol.

According to one embodiment, the polyol represents from 1 to 5% of the total weight of the composition.

Another subject of the invention relates to the method of preparing a thermoplastic composition as defined previously, comprising the following steps:
a) preparation of a masterbatch comprising a PA-11 or PA-12 polyamide resin or a blend of PA-11 and-PA-12 and melamine cyanurate; then
b) dilution of the masterbatch in a PA-11 or PA-12 resin or a blend of PA-11 and PA-12.

Preferably, the polyamide from step a) of the preparation method is PA-11 and the polyamide from step b) is PA-12.

According to one embodiment, a polyol is added to step b) of the preparation method.

The invention also relates to industrial articles obtained by conversion of the compositions as defined previously.

### DETAILED DESCRIPTION OF THE INVENTION

These compositions allow materials to be obtained that have good mechanical properties, good thermal and chemical resistance and good fire resistance. The materials obtained with the compositions according to the invention have both good combustion resistance and good mechanical properties (such as tensile strength or elongation at break), especially after ageing.

The polyamide PA resins present in the thermoplastic compositions according to the invention are known thermoplastic resins made up of nylon-11 (PA-11) polymers and nylon-12 (PA-12) polymers.

In the compositions according to the invention, the PA-12/PA-11 ratio generally lies within the range going from 99/1 to 1/99, preferably from 95/5 to 50/50 or else from 90/10 to 60/40.

According to a preferred embodiment, the PA-12/PA-11 ratio lies within the range going from 85/15 to 50/50.

The term “melamine cyanurate” is understood to mean compounds resulting from the reaction of melamine with cyanuric acid, and particularly the compound resulting from the equimolar reaction of melamine with cyanuric acid, the latter possibly being in the enol or ketone form.

The melamine cyanurate incorporated into the masterbatch in general represents from 30 to 60% of the total weight of the masterbatch.

In the final compositions based on the mixture of PA-11 and PA-12, it in general represents from 5 to 20% of the total weight of the composition, and preferably from 10 to 15% of the total weight of the composition.

To the compositions according to the invention, additional fire-retardant additives may be added, chosen from one or more polyols, for example containing four lots of alcohol functional groups, antimony oxide Sb₂O₃, magnesium hydroxide Mg(OH)₂, ammonium polyphosphate, melamine pyrophosphate and more generally phosphorus derivatives such as phosphinates, phosphates such as TPP, RDP, etc. It would not be outside the scope of the invention to add mineral nanofillers to the thermoplastic composition. By way of example of these nanofillers, mention may be made of montmorillonite, nanotalcs, etc. Zeolites, known moreover for their application as molecular sieves, may also be added to these compositions.

The term “polyol” is understood to mean compounds preferably containing the alcohol functional group at least four times such as tetrols, such as erythrol, monopentaerythritol (PER) and its polysubstituted derivatives, pentols, such as xylitol, arabitol and hexols, such as mannitol, sorbitol and its higher homologues.

The preferred additives chosen from one or more polyols containing the alcohol functional group at least four times is monopentaerythritol (PER).

The quantity of polyol represents from 1 to 5% of the total weight of the final composition.

Antimony oxide Sb₂O₃ is present, in general, in the form of a fine powder of which the particle size is around one micron.

The compositions according to the invention may also contain polyamide-based thermoplastic elastomers (TPE) which are block copolymers, also known as polyetheramides or polyesteramides, of which the rigid blocks are made up of polyamide and the flexible blocks are made up of polyether or polyester.

The compositions may also contain their blends with other polymers such as polyurethanes or polyolefins.

In all cases, the PA resin(s) as defined above represent at least 50% of the total weight of the blend.

More particularly mention may be made of the blends of PA and polyolefin elastomers that improve the impact strength of the PAs. As examples of these impact modifiers, mention may be made of ethylene-propylene rubbers (EPR) and ethylene-propylene-diene monomer (EPDM) rubbers; the latter may bear chemical functional groups such as, for example, maleic anhydride, ethylene-vinyl acetate (EVA) copolymers, ethylene-acrylic ester (EAD) copolymers and homologues thereof terpolymerized with maleic anhydride or glycidyl methacrylate, known under the trade name LOTADER produced by the Applicant.

The PAs may be plasticized using additives commonly used for this type of modification. They may be filled and/or contain various additives, for example additives intended to protect the PA against thermal oxidation or thermal/UV degradation, processing aids such as lubricants, dyes or pigments, etc.

Copolyamides may also be added to the thermoplastic composition. The term “copolyamides” is understood to mean the copolymers resulting from the condensation of at least two alpha,omega-aminocarboxylic acids or from two lactams or from one lactam and one alpha,omega-aminocarboxylic acid. Mention may also be made of the copolyamides resulting from the condensation of at least one alpha,omega-aminocarboxylic acid (or a lactam), at least one diamine and at least one dicarboxylic acid.

As examples of copolyamides, mention may be made of caprolactam/lauryl lactam (PA-6/12) copolymers, caprolactam, adipic acid and hexamethylenediamine (PA-6/6,6) copolymers, caprolactam, lauryllactam, adipic acid and hexamethylenediamine (PA-6/12/6,6) copolymers, caprolactam, lauryllactam, 11-aminoundecanoic acid, azelaic acid and hexamethylenediamine (PA-6/6,9/11/12) copolymers, caprolactam, lauryllactam, 11-aminoundecanoic acid, adipic acid and hexamethylenediamine (PA-6/6,6/11/12) copolymers and lauryl lactam, azelaic acid and hexamethylenediamine (PA-6,9/12) copolymers.

The preparation of compositions according to the invention is carried out by first preparing a masterbatch of PA-11 or PA-12 resin or a mixture of the two with melamine cyanurate by melt-blending it into PA resin; the mixing temperature is generally between 150 and 300° C. and preferably between 180 and 250° C.

The masterbatch has the advantage of ensuring good predispersion of the constituents that will be mixed once again during the subsequent dilution of the masterbatch in the final resin made up of PA-11 or PA-12 or a blend of the two. This method makes it possible to obtain compositions comprising a blend of two different PA-11 and PA-12 resins.

The additional additives described above may be added to the masterbatch or preferably to the dilution medium with the final resin(s).

A masterbatch based on the additional resin(s) described above may be produced, then diluted in the final resin. This system is particularly advantageous in the case of PA resins impact-strengthened with polyolefin elastomers: the fire-retardant additives mixed with the polyolefin elastomer make up the masterbatch that is subsequently diluted in the PA resin.

The Applicant has observed that a masterbatch based on a thermoplastic elastomer of PA-11 and melamine cyanurate subsequently diluted in a PA-12 resin makes it possible to obtain particularly advantageous compositions.

According to a preferred embodiment, monopentaerythritol is added to the final dilution step.

Compositions are produced that allow materials to be obtained that have both good combustion resistance and good mechanical properties (such as tensile strength or elongation at break), especially after ageing.

The compositions according to the invention find applications in various fields by conversion into industrial articles intended in particular for the automotive, aeronautics, domestic electrical appliance, audiovisual equipment and electrical equipment industries; they are well suited for the production of cabling components, for example electrical equipment. These thermoplastic compositions may also find applications in the field of sheathing plastic optical fibres. They are particularly suitable for conversion into compression-moulded, extruded or injection-moulded articles, into films, into sheets, into fibres, into composition materials such as coextruded articles or multilayer films, and also into powders for coating substrates.

In everything that follows, the inherent viscosity of the PAs is measured at 25° C. in meta-cresol for 0.5 g of polymer in 100 ml of meta-cresol.

The melting point of the PA resins is measured according to the standard ASTM D 3418 and their Shore D hardness is measured according to the standard ASTM D 2240.

The tensile properties EBᵢ and EB_{f} (initial and final elongation at break) and TSᵢ and TS_{f} (initial and final tensile strength) are measured according to the standard ISO R 527 IB.

Ageing is carried out by heating at 90° C. for 14 days in a ventilated oven.

The flexural modulus (FM) is measured according to standard ISO 178.

The fire resistance is evaluated by measuring the limiting oxygen index (LOI) on ISO R178 rods (80×10×4 mm³) obtained on a KRAUSS MAFFEI BI 60T moulding machine from the above samples, under the following conditions:
Injection temperature: 210-230° C.;
Mould temperature: 35° C.;
Injection pressure: about 900 bar;
Hold pressure: about 400 bar;
Hold time: 25 s;
Cooling time: 20 s.

The drip resistance (UL 94) is evaluated according to the standard NF 51 0272.

Except where otherwise indicated, the proportions are expressed by weight.

### EXAMPLES

The following examples illustrate the present invention without limiting it.

### Preparation of MB1 and MB2 Masterbatches

Introduced into a corotating Werner & Pfleiderer ZSK 40 twin-screw extruder (diameter=40 mm, L=40 D), the barrel of which was heated to 200° C. (flat profile), were the PA-12 or PA-11 resins in granule form and the melamine cyanurate (MC). The weight percentages of the various reactants are listed in Table 1.

TABLE 1

| Masterbatch | PA-12 | PA-11 | MC |
|---|---|---|---|
| MB1 | 60 | | 40 |
| MB2 | | 60 | 40 |

The PA-12 (melting point: 175° C.; viscosity=1.1) and the PA-11 (melting point: 185° C.; viscosity=1.1) are sold by the Applicant.

The melamine cyanurate (MC) used is sold by Ciba under the trade reference MELAPUR MC 25.

### Examples 1 to 4

The above masterbatches were then diluted with PA-12 in the presence of 2% by weight of monopentaerythritol (PER) and 1.2% by weight of a conventional heat stabilizer made up of a mixture of hindered phenol and a phosphite (5 parts of IRGANOX 1098 and 2 parts of IRGAFOS 168, these two products being sold by Ciba) in a corotating Werner & Pfleiderer ZSK 40 twin-screw extruder (diameter=40 mm, L=40 D), the barrel of which was heated to 260° C. (flat profile).

The monopentaerythritol (PER) used is sold by Celanese.

The fire resistance (LOI & UL 94) and the initial and final mechanical properties after ageing of the compositions obtained were evaluated on rods, dumbbells or sheets according to the operating conditions of the measurement standards used.

The results of the LOI measurement and the mechanical properties and also the masterbatch concentration (% dilution by weight) are quoted in Table 2.

TABLE 2
Examples 1, 2 and 5 are provided by way of comparison

| | Comparative | Comparative | | | Comparative |
|---|---|---|---|---|---|
| | example 1 | example 2 | Example 3 | Example 4 | example 5**** |
| Dilution (%) | 30 | 35 | 30 | 35 | 30 |
| PA-11 (%) | | | 18* | 21* | 84.8 |
| | | | | | (18* + 66.8**) |
| PA-12 (%) | 84.8 | 82.8 | 66.8** | 61.8** | |
| | (18* + 66.8**) | (21* + 61.8**) | | | |
| MC (%) | 12 | 14 | 12 | 14 | 12 |
| PER (%) | 2 | 2 | 2 | 2 | 2 |
| Stabilizer (%) | 1.2 | 1.2 | 1.2 | 1.2 | 1.2 |
| EBᵢ (%) | 412 | 397 | 441 | 446 | |
| TSᵢ (MPa) | 41.4 | 37.6 | 47.6 | 40.4 | |
| EB_{f} (%) | 217 (53%) | 114 (29%) | 369 (84%) | 420 (94%) | |
| (retention)*** | | | | | |
| TS_{f} (MPa) | 41 (99%) | 39 (104%) | 42.4 (89%) | 43.1 (107%) | |
| (retention)*** | | | | | |
| FM (MPa) | 1293 | 1355 | 1141 | 1117 | |
| LOI 3.2 mm | 29.6 | 32 | 33.9 | 33.9 | 30.1 |
| UL94 1.6 mm | V2 | V2 | V2 | V0 | V2 |

The amounts of constituents in the final composition, after dilution, are given as % by weight of the total composition:
*corresponds to the amount of PA in the masterbatch;
**corresponds to the amount of PA in the dilution medium;
***corresponds to the ratio between the value of the property after ageing and that before ageing;
****Test 5 was carried out with a PA-11 (melting point: 185° C.; viscosity = 1.1) both for the production of the MB and for the dilution.

1. A flame-retardant thermoplastic composition comprising a blend of PA-11 and PA-12 polyamide resins and melamine cyanurate, the PA-12/PA-11 ratio lying within the range going from 90/10 to 50/50.

2. The composition according to claim 1, in which the PA-12/PA-11 ratio lies within the range going from 85/15 to 60/40.

3. (canceled)

4. The composition according to claim 1, in which the melamine cyanurate represents 5 to 20%, of the total weight of the composition.

5. The composition according to claim 1, which further comprises at least one fire-retardant additive selected from the group consisting of polyols containing the alcohol functional group at least four times, antimony oxide Sb₂O₃, magnesium hydroxide Mg(OH)₂, ammonium polyphosphate, phosphorus (P) derivatives or mineral nanofillers.

6. The composition according to claim 5, in which the polyol is monopentaerythritol.

7. The composition according to claim 5, in which the polyol represents from 1 to 5% of the total weight of the composition.

8. The composition according to claim 1 prepared by the following steps:
a) preparing a masterbatch comprising a PA-11 or PA-12 polyamide resin or a blend of PA-11 and PA-12 and melamine cyanurate; then
b) diluting the masterbatch in a PA-11 or PA-12 resin or a blend of PA-11 and PA-12.

9. The method according to claim 8, in which the polyamide from step a) is PA-11 and the polyamide from step b) is PA-12.

10. The method according to claim 8, in which a polyol is added to step b).

11. (canceled)

12. The composition according to claim 4, in which the melamine cyanurate represents from 10 to 15% of the total weight of the composition.
